(19) United States
(12) Patent Application Publication
(10) Pub. No.: US 2025/0216675 A1
(43) Pub. Date: Jul. 3, 2025

(54) DIRECT REFLECTION SYSTEM FOR HEAD UP DISPLAY

(71) Applicant: N.S. International, Ltd., Troy, MI (US)

(72) Inventor: Joseph Pullukat, Troy, MI (US)

(21) Appl. No.: 19/006,528

(22) Filed: Dec. 31, 2024

Related U.S. Application Data
(60) Provisional application No. 63/616,681, filed on Dec. 31, 2023.

(51) Int. Cl. G02B 27/01; B60K 35/231

(52) U.S. Cl. CPC G02B 27/0101; B60K 35/231

(57) ABSTRACT

A direct reflection system for a head up display according to the present disclosure comprises a windshield display and a filter film which blocks a user's view of the windshield display while allowing a reflection of the windshield display to be viewed on the vehicle's windshield. In preferred embodiments, the filter film is a louver film. In some embodiments, multiple windshield displays facilitate separate reflections before the driver's seat, the front passenger seat, and a center console. To facilitate a better image reflected off the windshield, a viewing portion, or portions, of the windshield may be tinted or otherwise darkened with a black print. In a preferred embodiment, a dark ceramic enamel coats the viewing portion(s) of the windshield. In a preferred embodiment, an anti-reflective coating coats the external surface of the filter film to reduce the reflection of the display output from the windshield back onto the windshield display.

### CROSS-REFERENCE TO RELATED APPLICATIONS

This application claims priority to U.S. Provisional Application No. 63/616,681 filed on Dec. 31, 2023, which is hereby incorporated by reference in its entirety for all purposes.

### TECHNICAL FIELD

The present disclosure relates generally to the field of head up displays (HUD). More specifically, the present disclosure relates to a direct reflection system in a HUD.

### BACKGROUND

The use of a head up display (HUD) in vehicles is known in the prior art. A HUD is a means of projecting or reflecting an image directly into a user's visual field in such a way as to overlap a background scene without interfering with the user's view of the background scene. In automobiles, this generally means that information contained in the image is reflected onto a portion of a vehicle's windshield in a semi-transparent manner so that a driver can quickly and easily acquire information such as, but not limited to, speed, navigation assistance, engine performance, and operating conditions, without directing the driver's attention away from the road.

In some instances, the image is first exhibited upon a digital display positioned within a HUD assembly which is in turn housed within a dashboard of the vehicle. In such instances the image exhibited upon the display is reflected off a plurality of mirrors and/or lenses that are also housed within the HUD assembly, before being reflected onto the windshield.

However, in other instances, a digital display is mounted on or within the vehicle's dashboard directly under the windshield. The image exhibited upon the display is thus reflected directly off the windshield without first being reflected off the plurality of mirrors and/or lenses. This reduces the size of the HUD. It also allows the HUD to be inserted shallowly within the dashboard, or to be mounted upon an exterior of the dashboard, thereby utilizing less space within the dashboard. However, in this orientation, both the image on the actual display and the reflected image on the windshield may be visible to the driver, which can be distracting. Optimally, only the reflection in the windshield would be visible to the driver, not the image exhibited upon the display itself.

Accordingly, there is an unmet need for a HUD comprising a digital display that can be mounted on or within a dashboard of a motor vehicle in such a way that an image exhibited on the display may be reflected off a windshield to be visible to a user, but where the display image is itself blocked from the user's view, thereby resolving the foregoing problems in the prior art.

### SUMMARY

The present disclosure relates to a direct reflection system for a head up display (HUD) for use in a vehicle, wherein the direct reflection system comprises a windshield display and a reflective surface such as a windshield. The windshield display comprises an image source and a display surface, where the image source generates an image on the display surface. The image exhibited upon the display surface is then reflected off the windshield. To facilitate reflection of the display surface, the windshield display is preferably mounted upon or within a dashboard of the vehicle directly under the windshield. However, this orientation can result in a dual image, with one image exhibited upon the display surface of the windshield display and the other exhibited as the reflection in the windshield. To limit a user's view to a single image, and to reduce the possibility that the two images would distract the user, preferred embodiments additionally comprise a visual barrier that blocks the user's view of the windshield display while still facilitating the reflection in the windshield, and the user's view thereof.

In some embodiments, the visual barrier is a filter film which covers the display surface of the windshield display. In preferred embodiments, the filter film is a louver film that comprises a plurality of louvers that are angled such that the filter film acts as a visual barrier, blocking a user's view of the windshield display while allowing the windshield display to be reflected off the vehicle's windshield.

In some embodiments, the windshield display is mounted within the dashboard such that a display surface of the windshield display is flush with an external surface of the dashboard. In other embodiments, the windshield display is mounted on top of the external surface of the dashboard. Alternatively, the windshield display may be mounted shallowly within the dashboard such that it sits in a shallow well in the dashboard, but not so deeply that the windshield display interferes with other components of the vehicle housed within the dashboard.

In some embodiments, the reflection of the windshield display may be visible to multiple users within the vehicle, preferably including the driver and passengers. In other embodiments, multiple windshield displays are mounted on or in the dashboard of the vehicle, creating separate reflections in front of the driver's seat, front passenger seat, and/or center console of the vehicle. The use of multiple windshield displays may facilitate exhibition of tailored visual displays based on the targeted individual to whom the image is intended to be displayed.

To facilitate a high-quality image reflected off the windshield, a viewing portion, or portions, of the windshield where the image(s) of the windshield display(s) may be reflected may be tinted or otherwise darkened with a dark print. In a preferred embodiment, the viewing portion(s) of the windshield are coated with a black ceramic enamel.

In a preferred embodiment, an external surface of the filter film is coated in an anti-reflective coating. This coating may reduce the reflection of the display output from the windshield back onto the windshield display. It may also reduce glare or reflection of external sunlight or other ambient light off the windshield display and may function to protect the windshield display from damage from sunlight.

Preferred embodiments may additionally comprise an infrared (IR) coating that selectively blocks and/or reflects infrared wavelengths of light while permitting visible light to pass through components of the direct reflection system. The IR coating may cover surfaces of windshield display and/or the filter film that may be exposed to sunlight or other sources of infrared radiation. The IR coating thus serves to protect components of the direct reflection system from IR radiation and minimizes heat transferred by the IR light, maintaining a lower temperature of the louver film and windshield display, and preventing or mitigating damage that might occur due to excess heat exposure.

In preferred embodiments, components of the direct reflection system, such as the windshield display and louver film, are optically bonded together, thereby reducing air gap between components, and reducing a potential for a double image or optical distortions that may be cause by reflections or refractions at air interfaces.

A preferred embodiment of the present invention comprises:

A direct reflection system of a head up display (HUD) of a vehicle, the direct reflection system comprising:
a windshield display, the windshield display comprising:
   an image source; and
   a display surface;
a filter film;
a reflective surface; and
a reflection pathway defined by the windshield display and the reflective surface;
wherein the image source is configured to emit light which is transmitted to the display surface such that an image is exhibited upon the display surface;
wherein light from the image is reflected along the reflection pathway such that the image is reflected off the reflective surface;
wherein the filter film permits the light from the image to be reflected along the reflection pathway while blocking a peripheral sightline of the windshield display.

### BRIEF DESCRIPTION OF THE DRAWINGS

The invention will be more fully understood by referring to the following Detailed Description of Specific Embodiments in conjunction with the Drawings, of which:

FIG. 1 is a cross section view of a front end of a passenger compartment of a motor vehicle provided in accordance with the prior art, illustrating a traditional HUD system, a direct reflection system, and a dashboard display.

FIG. 2 is a schematic of a direct reflection system of a motor vehicle, provided in accordance with the prior art.

FIG. 3 is a schematic of the direct reflection system of FIG. 2, wherein a visual barrier is positioned on top of a dashboard of the vehicle, provided in accordance with the prior art.

FIG. 4 is a schematic of a direct reflection system of a motor vehicle provided in accordance with an embodiment of the current disclosure, wherein a filter film covers a windshield display.

FIG. 5 is a schematic of the direct reflection system of FIG. 4 illustrating a plurality of louvers that comprise the filter film.

FIG. 6A is a schematic of the direct reflection system of FIG. 4, provided in accordance with an embodiment of the current disclosure, wherein the windshield display and filter film are embedded within a dashboard of the vehicle such that a top surface of the windshield display is flush with an external surface of the dashboard.

FIG. 6B is a schematic of the direct reflection system of FIG. 4, provided in accordance with an embodiment of the current disclosure, wherein the windshield display and filter film are mounted upon an external surface of the dashboard.

FIG. 6C is a schematic of the direct reflection system of FIG. 4, provided in accordance with an embodiment of the current disclosure, wherein the windshield display and filter film are embedded within a shallow well within the dashboard.

FIG. 7 is an exploded view of a windshield display assembly provided in accordance with an embodiment of the current disclosure.

FIG. 8 is a schematic of the direct reflection system of FIG. 4, provided in accordance with preferred embodiments of the current disclosure, wherein the filter film permits emission of light from the windshield display such that reflections off the windshield are visible to users of varying heights.

FIG. 9 is schematic illustrating a cross section of the filter film of the direct reflection system of FIG. 4, provided in accordance with preferred embodiments of the current disclosure.

FIG. 10A is a schematic of the direct reflection system of FIG. 4, provided in accordance with preferred embodiments of the current disclosure, illustrating reflection pathways from the windshield display for users of varying heights.

FIG. 10B is a schematic of the direct reflection system of FIG. 4, provided in accordance with preferred embodiments of the current disclosure, illustrating peripheral sightlines of users of varying heights and the windshield display.

FIG. 11a is schematic illustrating a cross section of the filter film of FIG. 4, where the filter film is coated in an anti-reflective coating, provided in accordance with a preferred embodiment of the current disclosure.

FIG. 11b is a schematic illustrating a cross section of the filter film and anti-reflective coating of FIG. 11a, additionally illustrating the windshield display of FIG. 4, as provided in accordance with a preferred embodiment of the current disclosure.

FIG. 12a is a schematic illustrating positional relationships between a filter film, anti-reflective coating, infrared coating, optical bonding layer, and display, provided in accordance with a preferred embodiment of the current disclosure.

FIG. 12b is a schematic illustrating positional relationships between a filter film, anti-reflective coating, infrared coating, optical bonding layer, and display, provided in accordance with a preferred embodiment of the current disclosure.

FIG. 12c is a schematic illustrating positional relationships between a filter film, anti-reflective coating, infrared coating, optical bonding layer, and display, provided in accordance with a preferred embodiment of the current disclosure.

FIG. 12d is a schematic illustrating positional relationships between a filter film, anti-reflective coating, infrared coating, optical bonding layer, and display, provided in accordance with a preferred embodiment of the current disclosure.

FIG. 12e is a schematic illustrating positional relationships between the filter film, anti-reflective coating, infrared coating, optical bonding layer, and display, provided in accordance with a preferred embodiment of the current disclosure.

FIG. 12f is a schematic illustrating positional relationships between a filter film, anti-reflective coating, infrared coating, optical bonding layer, and display, provided in accordance with a preferred embodiment of the current disclosure.

FIG. 12g is a schematic illustrating positional relationships between a filter film, anti-reflective coating, infrared coating, optical bonding layer, and display, provided in accordance with a preferred embodiment of the current disclosure.

FIG. 12h is a schematic illustrating positional relationships between a filter film, anti-reflective coating, infrared coating, optical bonding layer, and display, provided in accordance with a preferred embodiment of the current disclosure.

FIG. 13 is a perspective view of a viewing portion of a windshield provided in accordance with preferred embodiments of the current disclosure.

FIG. 14 is a perspective view of multiple windshield display reflections provided in accordance with an embodiment of the current disclosure.

FIG. 15 is a cross sectional view of a dashboard of the motor vehicle, illustrating multiple windshield displays provided in accordance with an embodiment of the current disclosure.

### DETAILED DESCRIPTION OF SPECIFIC EMBODIMENTS

Embodiments of the present disclosure relate generally to an improved direct reflection system for a head up display (HUD). The present disclosure describes, in detail, specific embodiments with the understanding that the present invention may be susceptible to embodiments in different forms, and that the present disclosure is considered an exemplification of the principles of the invention and is not intended to limit the invention to that described herein.

As used in this disclosure, the term “user” may refer to the driver and/or the passenger or passengers of a vehicle. As used in this disclosure, the term “dashboard” and “dash” may be used interchangeably to refer to a panel of a vehicle that is facing the driver and which contains instruments or controls of the vehicle. The terms “louver film” and “louvre film” may be used interchangeably within this disclosure to designate a type of filter film that comprises a plurality of angled slats or fins. The terms “louver” and “louvre” may be used interchangeably to designate those slats. Moreover, notwithstanding the use of different reference numerals in the embodiments, the component parts of the direct reflection system described in the current disclosure may be the same or similar.

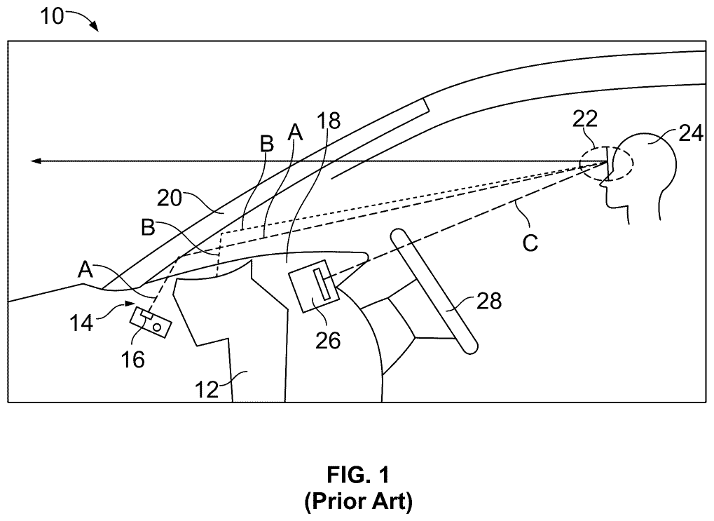

Generally, a traditional HUD 12, illustrated in FIG. 1, is a means of displaying an image directly within a user's visual field in such a way as to overlap a background scene without interfering with the user's view. In vehicles such as a car, truck, or other automobile, this generally means that information contained in the image is reflected on a portion of a vehicle's windshield 20, or other suitable reflective surface, in a semi-transparent manner so that a driver can quickly and easily acquire information such as, but not limited to, speed, navigation assistance, engine performance, and operating conditions, without directing the driver's attention away from a road or other background. In a traditional HUD 12, the image is reflected off at least one mirror or lens, such as a fold mirror or freeform mirror, before being reflected off the windshield 20. In such instances, the display and at least one mirror or lens are housed within a HUD module, which is in turn buried within a dashboard 18 of the vehicle.

However, other HUD devices may comprise a direct reflection system 14, 44 illustrated in FIGS. 1-4, wherein a windshield display 16, 46 is mounted upon, or mounted within, the dashboard 18 of the vehicle directly under the windshield 20, 50 so that an image displayed upon the windshield display 16, 46 is reflected directly off the windshield 20, 50, without first being reflected off other mirrors or lenses. In some instances, a motor vehicle may utilize a traditional HUD 12 as well as a direct reflection system HUD 14, 44.

FIG. 1 illustrates a cross section view of a front end of a passenger compartment 10 of a motor vehicle that utilizes both a traditional HUD 12 as well as a direct reflection system 14. The direct reflection system 14 generally comprises a windshield display 16 that is mounted within a dashboard 18 of the vehicle, and a reflective surface such as a windshield 20 of a motor vehicle. An image exhibited upon the windshield display 16 is reflected off the windshield 20 along a reflection pathway A to a viewbox 22 of a user 24, where the viewbox 22 is a physical location where a user's eye or eyes may receive visual input from the user's surroundings. The traditional HUD 12 reflects an image onto the windshield 20 along a projection pathway B such that the user 24 may see the reflected image on the windshield 20. Some vehicles may also have a conventional dashboard display 26 that is housed in the dashboard 18 behind a steering wheel 28, and which is directly visible along a user's sightline C.

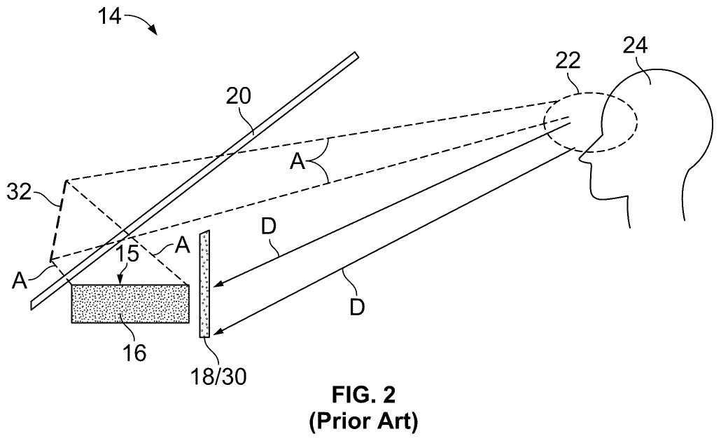

FIG. 2 is a schematic of the direct reflection system 14 in which the windshield display 16 generates an image that is reflected off the windshield 20. The windshield display 16 comprises a display surface 15, defined as a surface of the windshield display 16 closest to the windshield 20. Light generated by the windshield display 16 is exhibited upon the display surface 15 such that the resulting image can be reflected off the windshield 20. This results in two images, one exhibited upon the windshield display 16, and the other its mirror reflection 32 on the windshield 20. To remedy this, some direct reflection systems 14 may additionally include a visual barrier 30 between the user 24 and the windshield display 16. In some instances, the visual barrier 30 is defined by the dashboard 18 of the vehicle. This visual barrier 30 blocks the user's 24 view of the windshield display 16 while allowing the user 24 to see the reflection 32 of the display surface 15 in the windshield 20 of the motor vehicle. In other words, the visual barrier 30 blocks the user's 24 peripheral sightline D of the windshield display 16 but does not block reflection pathway A, and thus does not impede the user's 24 view of the reflection 32. Because of the position of the windshield display 16, and the nature of image reflection, the reflection 32 of the display 16 will typically appear to exist behind or beyond the windshield 20 when viewed by the user 24.

One traditional way to block the user's peripheral sightline D of the windshield display without the barrier 30 also infringing the user's view of the reflection 32, is to embed the windshield display 16 deeply within the dashboard 18 of the vehicle. In such instances, the dashboard 18 acts as the visual barrier 30 and obstructs the user's 24 view of the windshield display 16 by intruding into the user's 24 peripheral sightline D. By obstructing the user's 24 view of the windshield display 16, the dashboard 18 mitigates any distraction that may be caused by an extraneous view of the windshield display 16.

However, for the dashboard 18 to be effective as a visual barrier 30, the windshield display 16 must be embedded to such a depth that the dashboard 18 will hide the entirety of the windshield display 16 from the user's 24 view. Unfortunately, this often means that the windshield display 16 takes up space necessary for other components housed within the dashboard. However, if the windshield display 16 is embedded less deeply within the dashboard 18, portions of the windshield display 16 may be visible to, and thereby be a distraction to, the user 24.

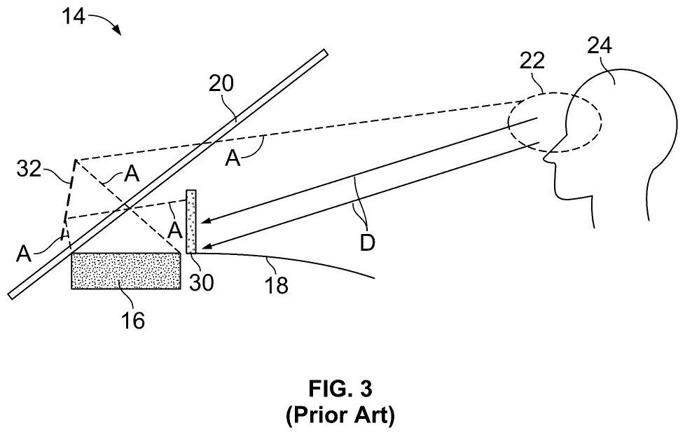

Alternatively, as shown in FIG. 3, some windshield displays 16 may be embedded less deeply, and an additional barrier 30 may be placed on top of the dashboard 18 to interrupt the user's 24 peripheral sightline D. However, in such instances, the additional barrier 30 often intrudes into reflection pathway A, thereby preventing portions of the reflection 32 from being visible to the user 24.

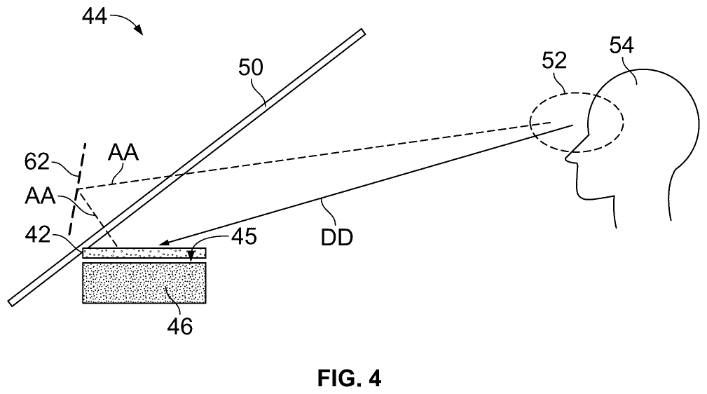

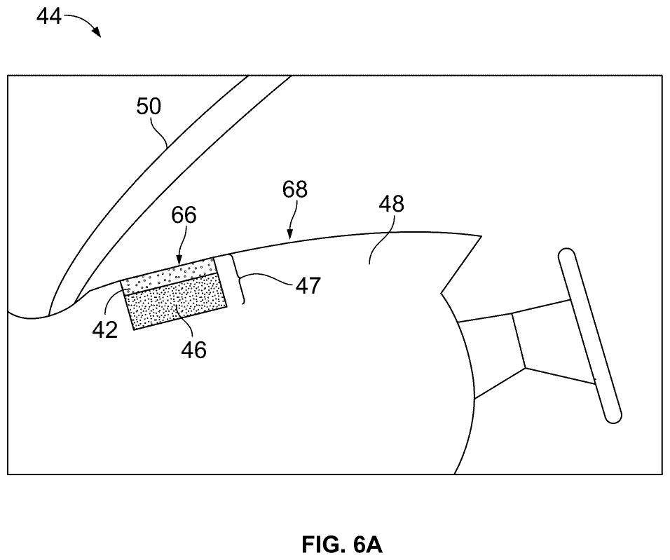

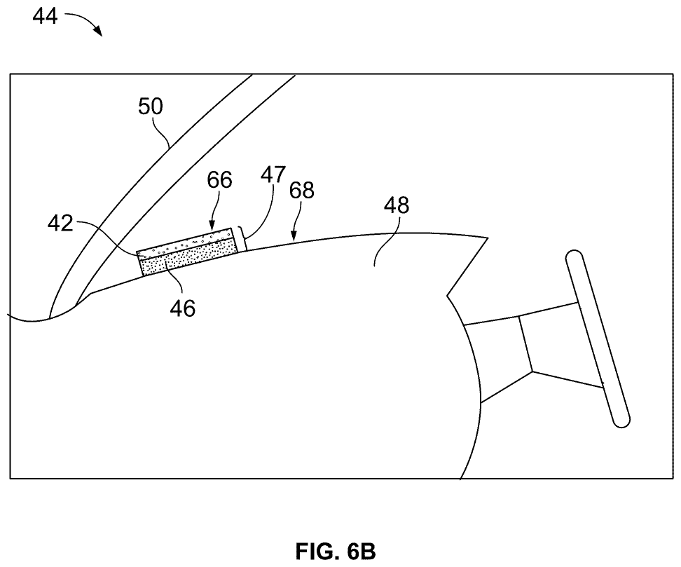

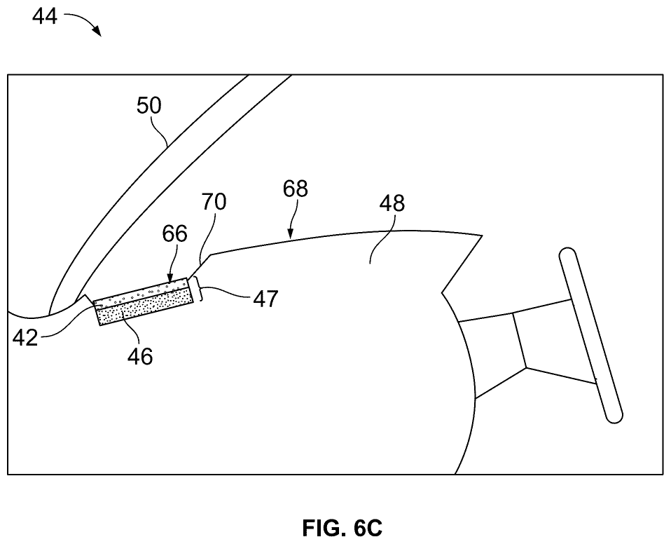

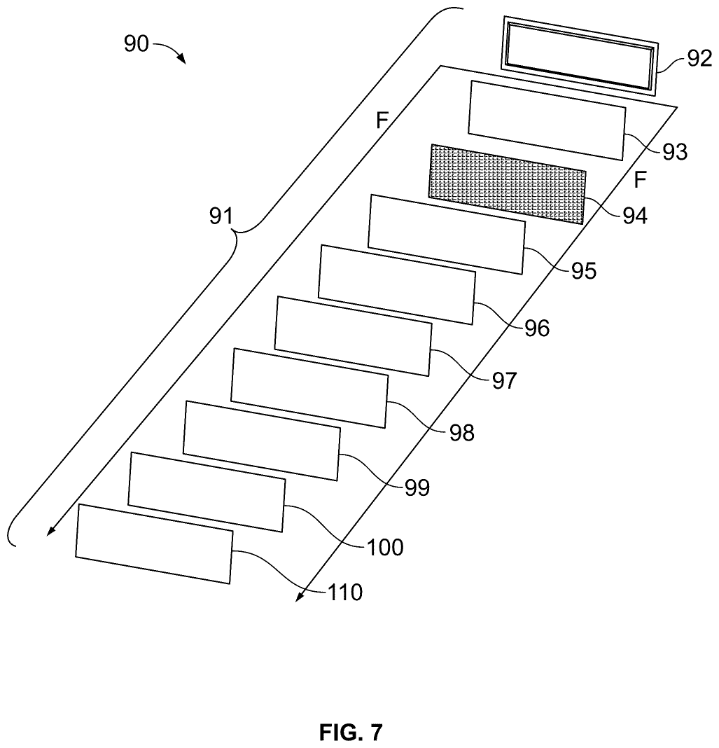

FIG. 4 is a schematic illustrating a preferred embodiment of the present disclosure where a direct reflection system 44 comprises a windshield display 46, a reflective surface such as a windshield 50, and a filter film 42. The windshield display 46 preferably comprises an image source, or light array 94 (shown in FIG. 7), and a display surface 45. The display surface 45 is preferably defined as a surface of the windshield display 46 closest to the windshield 50. The image source/light array 94 is preferably configured to emit light which is transmitted to the display surface 45 to produce an image which is exhibited upon the display surface 45. In preferred embodiments, the windshield display 46 is mounted upon, or mounted flush within, a dashboard 48 of the vehicle (not shown in FIG. 4, see FIGS. 6A, 6B, and 6C), and is positioned directly under the windshield 50 so that an image displayed upon the windshield display 46 is reflected off the windshield 50. Light emitted from the windshield display 46 thus travels along a reflection pathway AA to a viewbox 52 of a user 54, allowing the user 54 to see a reflection 62 of the windshield display 46 in the windshield 50. The filter film 42 permits light to travel along reflection pathway AA while blocking a user's peripheral sightline DD of the windshield display 46.

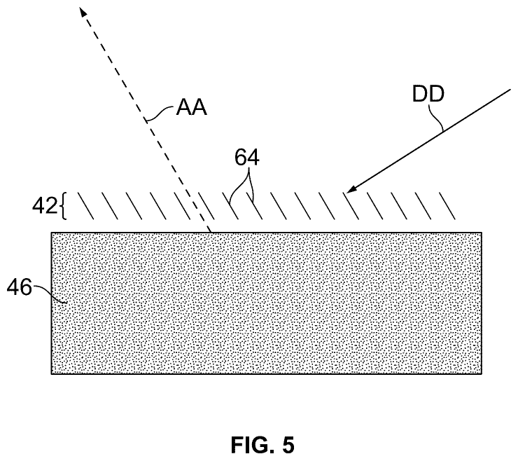

The filter film 42 thus functions to block the user's 54 view of the image exhibited on the windshield display 46 while still allowing the image to be reflected off the windshield 50. In preferred embodiments, as illustrated in FIG. 5, the filter film 42 is a louver film that comprises a plurality of angled slats, fins, or louvers 64 that are angled such that the filter film 42 acts as a visual barrier along the peripheral sightline DD but does not obstruct the reflection pathway AA.

Use of the filter film 42 removes the need for an external barrier to block the user's 54 direct view of the windshield display 46, which means that the windshield display 46 does not need to be deeply embedded within the dashboard 48. Instead, as illustrated in FIG. 6A, the windshield display can be mounted within the dashboard 48 such that a top surface 66 of a direct reflection system assembly 47 is flush with an external surface 68 of the dashboard 48. The direct reflection system assembly 47 may comprise either the windshield display 46 by itself, or both the windshield display 46 and the filter film 42. The top surface 66 is an outermost surface of the direct reflection system assembly 47. Thus, depending on a positional or assembly relationship between the filter film 42 and windshield display 46, the top surface 66 may be defined by an outer surface of the windshield display 46, or by an outer surface of the filter film 42.

In other embodiments illustrated in FIG. 6B, the windshield display 46 is mounted on top of the external surface 68 of the dashboard 48. Alternatively, as shown in FIG. 6C, in some embodiments, the windshield display 46 may be embedded or mounted shallowly within the dashboard 48 such that it sits in a shallow well 70 in the dashboard 48. In such embodiments, the shallow well 70 is preferably shallow enough that the windshield display 46 does not interfere with other components of the vehicle housed within the dashboard 48.

The filter film 42 preferably serves as a complete visual barrier between the user 54 and the windshield display 46. In some embodiments, the filter film 42 is positioned directly on top of the windshield display 46. In such instances, the filter film 42 preferably covers an entire area of the top surface 66 that may be within the user's 54 field of view.

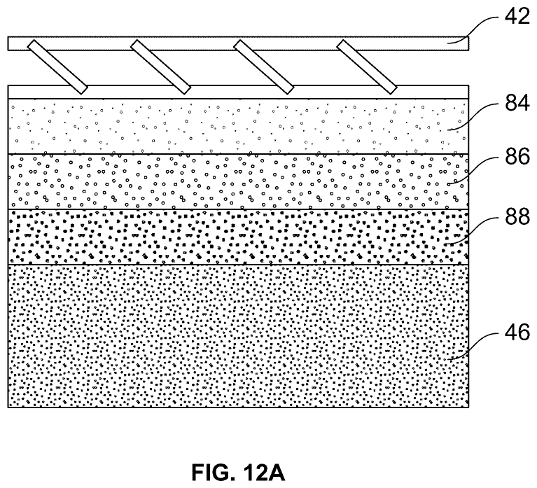

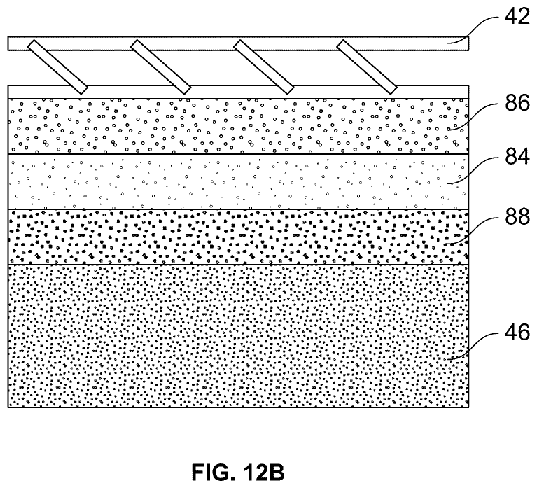

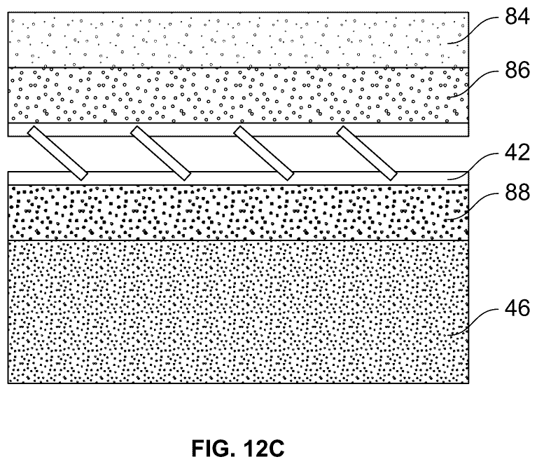

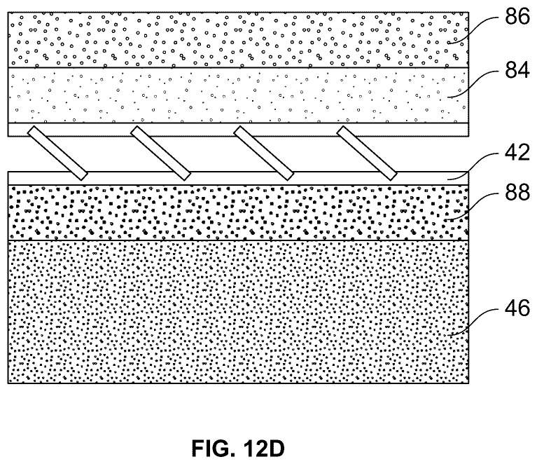

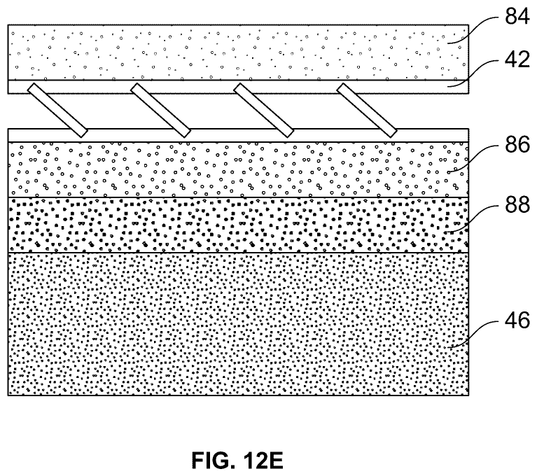

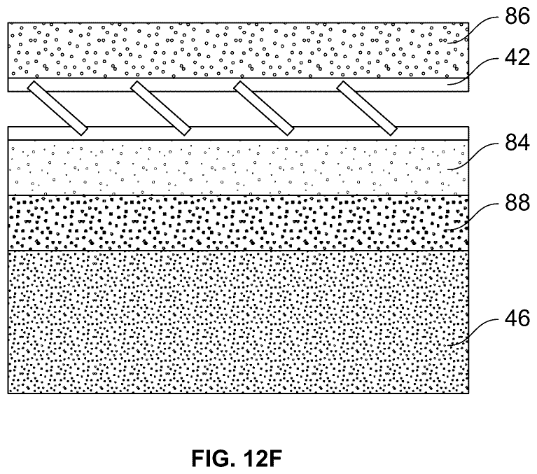

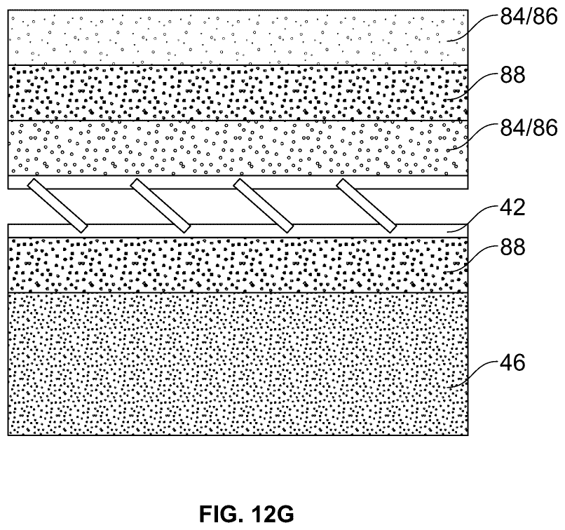

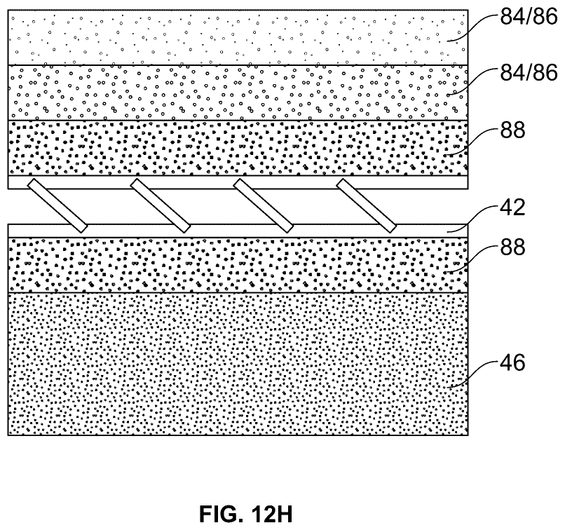

As seen in FIG. 7, the windshield display 46 is composed of a plurality of components 91 that form a windshield display assembly 90, where the plurality of components 91 includes a light array 94. In some embodiments, the windshield display assembly 90 components 91 may additionally comprise a member of the group comprising a windshield display case 92, a double-sided tape/backlight 93, a reflector 95, a diffuser plate 96, a diffuser sheet 97, a prism sheet 98, a polarized reflection sheet 99, a peak shift prism sheet 100, a top frame 110, and any combination thereof. It is contemplated that not all of these components 91 will be present in every embodiment. It is also contemplated that the windshield display assembly 90 may comprise alternative or additional components 91, such as an infrared (IR) coating film (see FIGS. 12a-12h). The filter film 42 may be integrated between the plurality of components 90 of the windshield display 46 anywhere in front of the illumination array 92, as illustrated by cutout F-F.

The light array 94 emits light which is exhibited as the image upon the display surface 45 of the windshield display 46. In some embodiments, the filter film 42 is positioned directly on top of the windshield display 46, as shown in FIGS. 4-6. However, the filter film 42 may be effective so long as it is positioned between the illumination array 92 and the windshield 50, and between the illumination array 92 and the user 54. Thus, in some embodiments, the filter film 42 may be integrated between the plurality of components 90 of the windshield display 46 anywhere in front of the illumination array 92.

In still other embodiments, the filter film 42 is not directly attached or encased within the windshield display 46 but is held in place in such a way that it is located between the windshield display 46 and both the windshield 50 and user 54.

The filter film 42 may thus be fixed in place relative to the windshield display 46 through a variety of methods. In some embodiments, the filter film 42 is mechanically fastened directly to the display 46. In other embodiments, the filter film 42 is mechanically fastened to some other component of the vehicle between the windshield display 46 and the windshield 50 and user 54. In other embodiments, the filter film 42 is bonded to the windshield display 46 by suitable adhesives known in the art. In yet other embodiments, the filter film 42 may be optically bonded to the windshield display 46. Alternatively, in some embodiments, the filter film 42 is frictionally held in place and is sandwiched between layers of the windshield display assembly 90. Other embodiments with different adhesion or fixation methods with different relative positions of the filter film 42 and windshield display 46 are anticipated by this disclosure, so long as the filter film 42 functions to permit reflection of the windshield display 46 on the windshield 50 and to block direct view of the windshield display 46 from the view of the user 54.

In embodiments where the filter film 42 comprises a louver film, the angle of the plurality of louvers 64 is preferably customized to maximize a virtual image brightness and minimize a direct view display brightness to the user's 54 eye. In addition, the angle of the plurality of louvers 64 preferably yields a reflection 62 that is visible to users 54 of different heights. In some embodiments, this may be accomplished by using a louver film where an angle of the plurality of louvers 64 is adjustable. In other embodiments, the angle of the plurality of louvers 64 is fixed, but is such that it permits reflection along a reflection pathway visible to users 54 of all heights.

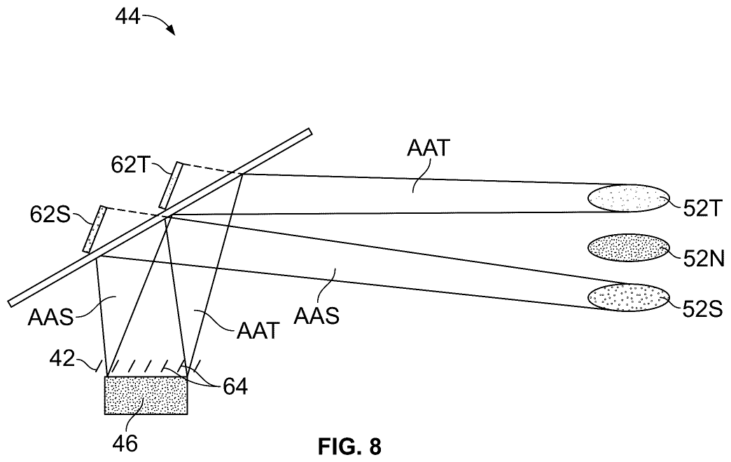

As illustrated in FIG. 8, a tall user will have a viewbox 52T that is higher than a viewbox 52S of a short user, with a viewbox 52N of a nominal user somewhere in-between. In order for the reflection of the windshield display 46 to be visible to users 54 of all heights, the angle of the louvers 64 in the filter film 42 must be such that the louvers 64 allow light to follow both a reflection pathway AAT and a reflection pathway AAS. A tall user will thus see a reflection 62T higher up on the windshield 50 than the reflection 62S that is visible to a shorter user.

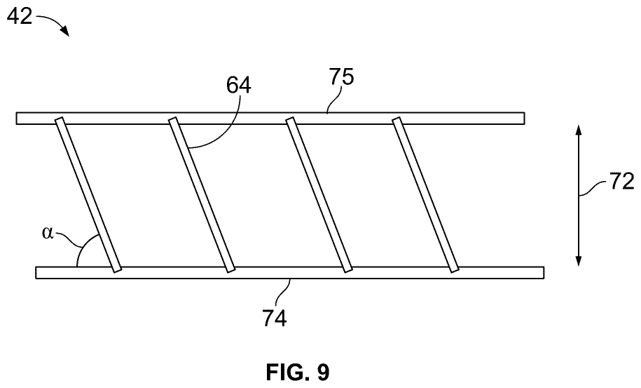

FIG. 9 is a cross sectional view of the filter film 42 in preferred embodiments where the filter film 42 comprises a louver film. The filter film 42 preferably defines a thickness 72. The plurality of louvers 64 are preferably positioned within the filter film 42 such that they stand upright between a base 74 and a top surface 75 of the film 74. In preferred embodiments, the louvers 64 are angled in such a way that they direct light from the windshield display 46 towards the windshield 50. The louvers 64 are thus positioned at a louver angle α in relation to the base 74.

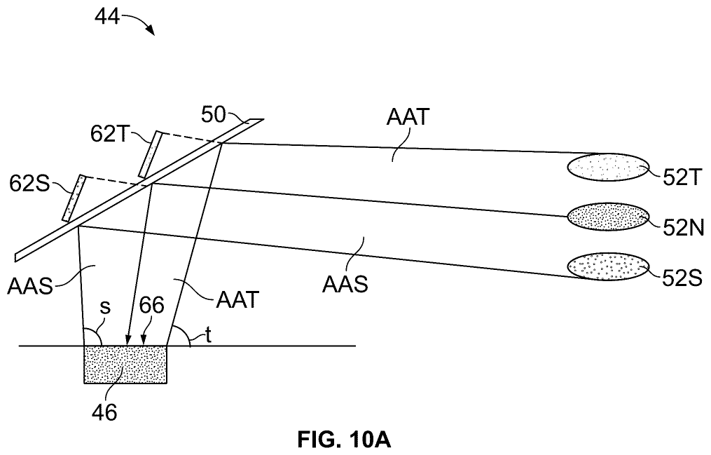

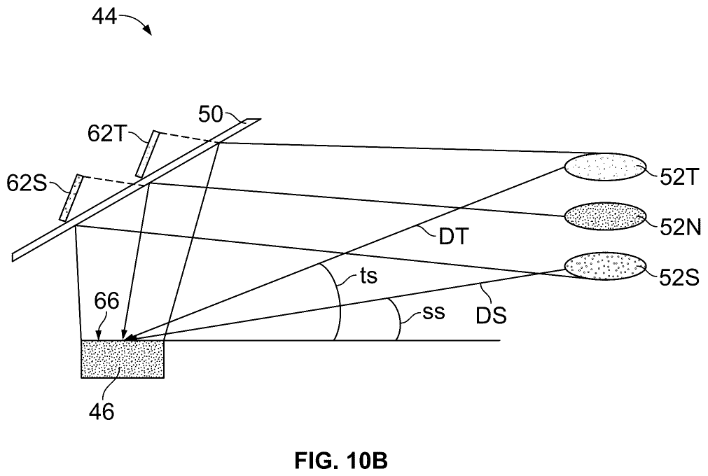

In preferred embodiments, and as illustrated in FIG. 10A, the louver film 42 directs light towards the windshield 50 at a range of angles from angle s to angle t. In such instances, angle s corresponds to a reflection pathway AAS that will produce reflection 62S that is visible to the shortest of users 54. On the other end of the range, angle t corresponds to a reflection pathway AAT that will produce reflection 62T that is visible to the tallest of users 54. The louver angle α is such that light may be transmitted at a variety of angles so that the image on the windshield display 46 may be reflected on the windshield 50 in such a way that it is visible to all users 54, regardless of their height.

To ensure that the reflection 62 is visible to users 54 at both extremes (tall and short), a pitch of the plurality of louvers 64 in the filter film 42 is preferably within the following constraints:

$$P \geq ABS [ H / ( tan ( angle s ) ) - H / ( tan ( angle α ) ) ] \qquad Constraint 1$$

$$and$$

$$P \geq ABS [ H / ( tan ( angle t ) ) - H / ( tan ( angle α ) ) ] \qquad Constraint 2$$

where P is the pitch of the louver film, H is the thickness 72 of the louver film, angle t is the angle between the reflection pathway AAT and a horizontal line continuous with the top surface 66 of the direct reflection system assembly 47, angle s is the angle between the reflection pathway AAS and the horizontal line continuous with the top surface 66, and angle α is the angle between the plurality of louvers 64 and the base 74 of the louver film 42.

Similarly, and as shown in FIG. 10B, the pitch of the plurality of louvers 64 (not shown) is preferably such that the louvers 64 block the windshield display 46 from view by users 54 at both height extremes. As such, the louvers 64 are preferably pitched to block both peripheral sightline DS, hitting the windshield display 46 at angle ss, and peripheral sightline DT which hits the windshield display 46 at angle ts, as well as at all peripheral sightlines between DT and DS.

To ensure that the windshield display 46 is obscured from view by users 54 at all heights, the pitch of the plurality of louvers 64 is preferably within the following constraints:

$$P \leq ABS [ H / ( tan ( angle ts ) ) - H / ( tan ( angle α ) ) ] \qquad Constraint 3$$

$$and$$

$$P \leq ABS [ H / ( tan ( angle ss ) ) - H / ( tan ( angle α ) ) ] \qquad Constraint 4$$

where P is the pitch of the louver film, H is the thickness 72 of the louver film 42, angle ts is the angle between the peripheral sightline DT and a horizontal line continuous with the top surface 66, angle ss is the angle between the peripheral sightline DS and the horizontal line continuous with the top surface 66 of the direct reflection system assembly 47, and angle α is the angle between the plurality of louvers 64 and the base 74 of the louver film 42.

In embodiments where Constraints 1-4 are met, the filter film 42 preferably permits reflection of the windshield display 46 such that the image exhibited may be viewed by users 54 of all heights while also blocking a direct view of the windshield display 46 from all users 54.

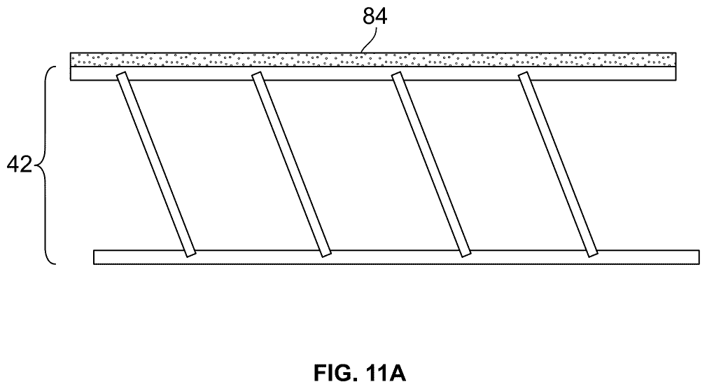

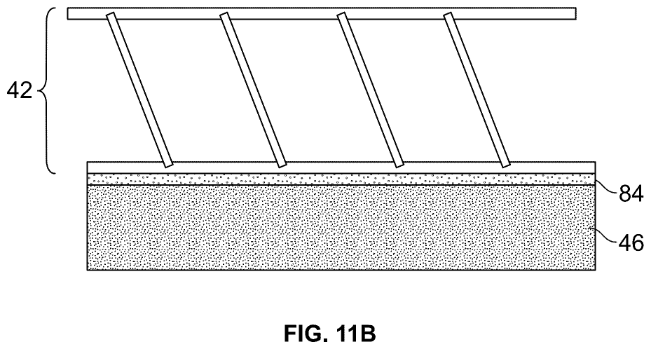

In a preferred embodiment illustrated in FIG. 11a, an external surface of the filter film 42 is coated in an anti-reflective coating 84. In another embodiment illustrated by FIG. 11b, the anti-reflective coating 84 coats the windshield display 46 and is positioned in-between the display 46 and the filter film 42. The anti-reflective coating 84 preferably prevents light from reflecting off the filter film 42 or display surface 45 into the user' 54 eye. The anti-reflective coating 84 may thus mitigate the risk of the windshield reflection 62 reflecting back to the windshield display 46, and thence back to the windshield 50. It thus reduces the risk of a double image reflected on the windshield 50. It may also reduce glare from the reflection of sunlight or other ambient light off the windshield display 46. The anti-reflective coating 84 may also function to protect the windshield display 46 from damage from sunlight. As used in this disclosure, the anti-reflective coating 84 may additionally be referred to as the “AR coating 84.”

FIGS. 12a-12h illustrate embodiments that may additionally comprise an infrared (IR) coating 86 and/or an optical bonding (OB) layer 88. The IR coating 86 preferably coats the filter film 42 and/or the display surface 45 of the windshield display 46 and reflects or blocks IR wavelengths of light, thereby minimizing heat transferred from IR light to the display 46. The OB layer 88 may comprise an Optically Clear Adhesive (OCA), or other transparent adhesive, which functions to optically bond the windshield display 46 to the filter film 42. Thus, in preferred embodiments, there is at least one OB layer 88 between the windshield display 46 and filter film 42. However, the direct reflection system 44 may comprise additional OB layers 88 wherever there are any air gaps between components of the reflection system 44. For instance, while the IR coating 86 and/or AR coating 84 may be layered directly on the windshield display 46 and/or filter film 42, they may instead coat separate sheets of transparent material (such as glass or plastic) which are stacked on top of the windshield display 46 and/or filter film 42. In such embodiments, additional OB layers 88 may be utilized to adhere the sheets bearing the IR coating 86 or AR coating 84 to the filter film 42 and/or display 46.

Various exemplary configurations of the windshield display 46, filter film 42, OB layer 88, AR coating 84, and IR coating 86 are exhibited in FIGS. 12a-12h. For example, and as illustrated in FIG. 12a, the IR coating 86 may be layered between the windshield display 46 and the AR coating 84. However, in other embodiments, illustrated in FIG. 12b, the IR coating 86 may be layered on top of the AR coating 84. In other embodiments illustrated in FIGS. 12c-12f, either the IR coating 86 or the AR coating 84, or both, may be layered on top of the filter film 42 instead of, or in addition to, coating the display surface 45 between the windshield display 46 and filter film 42. However, other configurations are also contemplated by this disclosure.

The IR coating 86 preferably minimizes heat conveyed to the windshield display 46 by IR wavelengths of light, which may be transmitted by sunlight or other ambient light sources. The IR coating 86 is thus preferably comprised of materials or substances that selectively block or reflect infrared light while permitting visible light to pass through. In some embodiments, the IR coating 86 is made up of metal oxides, dielectric materials, or multilayer interference coatings. However, other types of IR coatings 86 are contemplated by this disclosure. By blocking or reflecting IR wavelengths of light while permitting transmittance of visible wavelengths, the IR coating 86 limits the amount of heat conveyed to the filter film 42 and/or windshield display 46, preventing damage that may occur to the display 46 through excessive heat exposure, while still allowing light produced by the windshield display to reflect off the display surface 45.

Optical bonding preferably ensures that there is a minimal air gap between components of the direct reflection system 44, thereby reducing a potential for a double image formation or other optical distortions caused by reflection or refraction at air interfaces. In embodiments where the IR coating 86 and AR coating 84 are layered directly on the display surface 45 or on the filter film 42, there are preferably no air gaps between the IR and AR layers 86, 84, and thus the only OB layer required is between the windshield display 46 and filter film 42, as shown in FIGS. 12a-12d. However, in embodiments where the AR coating 84 and/or IR coating 86 are exhibited on their own transparent sheet, additional OB layers 88 may be utilized, as shown in FIGS. 12e-12h.

Other orientations and layering sequences for the windshield display 46, filter film 42, AR coating 84, IR coating 86, and/or OB layer(s) 88 are contemplated by this disclosure, and the embodiments illustrated in FIGS. 12a-h are meant only as examples. As noted above, in preferred embodiments, at least one OB layer 88 is provided between the windshield display 46 and filter film 42 to optically bond the two together. However, other OB layers 88 are contemplated to mitigate and minimalize any other gaps between any physical components. Likewise, in preferred embodiments, the AR coating 84 and/or IR coating 86 are layered on top of the windshield display 46. However, in some embodiments the AR coating 84 is on top of the IR coating 86, while in other embodiments the IR coating 86 is on top of the AR coating 84. Moreover, it is contemplated that the AR and/or IR coatings 84,86 may be applied directly to the display surface 45, that one or both coatings 84,86 may be applied directly to the filter film 42, or that one or both coating 84,86 are applied to both the display surface 45 and filter film 42; both the AR and IR coatings 84,86 may be placed on any layer on or above the display 46. In preferred embodiments, the AR coating 84 has a matt finish to facilitate its anti-reflective and anti-glare properties.

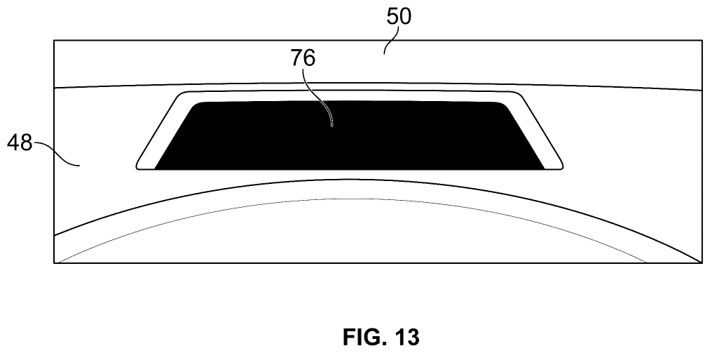

FIG. 13 illustrates an embodiment where a viewing portion 76 of the windshield 50 is tinted or otherwise darkened with a dark colored print. In some embodiments the viewing portion 76 is tinged with a black print. This facilitates a clearer image reflected off the windshield 50. In a preferred embodiment, the viewing portion 76 of the windshield is coated with a black ceramic enamel.

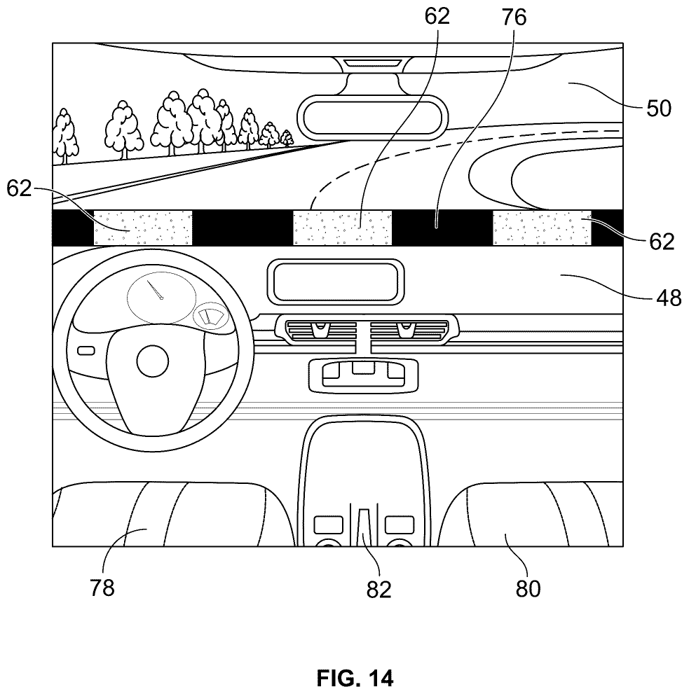

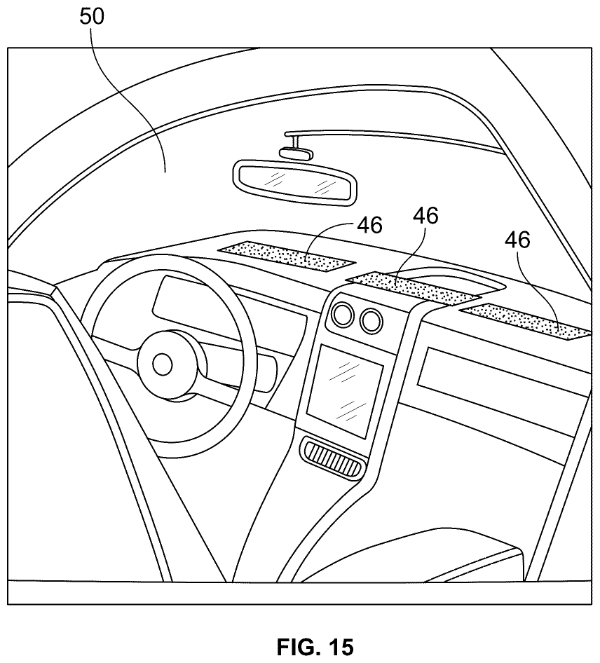

In some embodiments, the reflection 62 of the windshield display 46 may be visible to multiple users 54 within the vehicle, including the driver and any passengers. However, as illustrated in FIGS. 14 and 15, in other embodiments, multiple windshield displays 46 are mounted upon or in the dashboard 48 of the vehicle such that there is an individual reflection 62 before a driver's seat 78, before a front passenger seat 80, and/or before a center console 82 of the vehicle. The use of multiple windshield displays 46 may facilitate a tailored visual display based on the viewer. Other numbers and positions of windshield displays 46 and associated reflections 62 are also contemplated by this disclosure.

In preferred embodiments, the windshield display 46 is a thin, high contrast display that is capable of surviving direct sunlight without incurring sun or heat damage. In preferred embodiments, the windshield display 46 has a contrast ratio over 2500:1. The resolution of the windshield display 46 is preferably such that a number of pixels per degree is greater than 80 pixels per degree when viewed from a location of the user's view box 52. In a preferred embodiment, the windshield display 46 is a thin-film-transistor, or TFT display. In other embodiments, the windshield display 46 may comprise an organic light-emitting diode, or OLED. Alternatively, in some embodiments, the display may comprise a micro-LED. However, other types of displays are contemplated by this disclosure.

In some preferred embodiments, the louver film 42 is a privacy filter manufactured by 3M. However, other types of filter films 42 are contemplated by this disclosure, such as a perforated privacy film, or a film comprising molded slat plates.

In some embodiments, the direct reflection system 44 reflects the image off the clear, or transparent, glass of the windshield. However, in some other preferred embodiments, the viewing portion 76 of the windshield 50 is tinted or otherwise darkened with a dark colored print. This may achieve a viewing portion 76 that is tinted to be semi-transparent, or a viewing portion 76 that is completely black. In some embodiments, the viewing portion 76 may be tinted by painting the windshield 50 with a dark paint. In some embodiments, the windshield 50 is coated with a black ceramic enamel. In a preferred embodiment, the black ceramic enamel coats an exterior or outer surface of the windshield 50. However, it is also contemplated that the paint or ceramic may coat an interior or inner surface of the windshield 50. Moreover, other methods of darkening the viewing portion 76 of the windshield 50 are also contemplated by this disclosure.

While the invention is described through the above-described exemplary embodiments, modifications to, and variations of, the illustrated embodiments may be made without departing from the inventive concepts disclosed herein. For example, although specific parameter values, such as dimensions, materials, additives and coatings, may be recited in relation to disclosed embodiments, within the scope of the invention, the values of all parameters may vary over wide ranges to suit different applications.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A direct reflection system of a head up display (HUD) configured for use in a vehicle, the direct reflection system comprising:
a windshield display, the windshield display comprising:
an image source; and
a display surface;
a filter film;
a reflective surface; and
a reflection pathway defined by the windshield display and the reflective surface;
wherein the image source is configured to emit light which is transmitted to the display surface such that an image is exhibited upon the display surface;
wherein light from the image is reflected along the reflection pathway such that the image is reflected off the reflective surface;
wherein the filter film permits the light from the image to be reflected along the reflection pathway while blocking a peripheral sightline of the windshield display.

2. The direct reflection system of claim 1, wherein the filter film is optically bonded to the windshield display.

3. The direct reflection system of claim 1, additionally comprising an infrared coating film.

4. The direct reflection system of claim 1, additionally comprising an anti-reflective coating.

5. The direct reflection system of claim 1, wherein the reflection on the reflective surface is configured to be visible at varying heights.

6. The direct reflection system of claim 1, wherein the filter film is configured to obscure the windshield display from view at varying heights.

7. The direct reflection system of claim 1, wherein the filter film is a louver film.

8. The direct reflection system of claim 4, wherein the filter film comprises a plurality of louvers.

9. The direct reflection system of claim 8, wherein, to ensure that the reflection of the windshield display is configured to be visible at varying heights, a pitch of the plurality of louvers fits within the following Constraints:
$$P \geq ABS [ H / ( tan ( angle s ) ) - H / ( tan ( angle α ) ) ] \qquad Constraint 1$$
$$and$$
$$P \geq ABS [ H / ( tan ( angle t ) ) - H / ( tan ( angle α ) ) ] . \qquad Constraint 2$$

10. The direct reflection system of claim 8, wherein, to ensure that the windshield display is configured to be blocked from view at varying heights, a pitch of the plurality of louvers fits within the following Constraints:
$$P \leq ABS [ H / ( tan ( angle ts ) ) - H / ( tan ( angle α ) ) ] \qquad Constraint 3$$
$$And$$
$$P \leq ABS [ H / ( tan ( angle ss ) ) - H / ( tan ( angle α ) ) ] \qquad Constraint 4$$

11. The direct reflection system of claim 8, wherein a pitch of the plurality of louvers fits within the following Constraints:
$$P \geq ABS [ H / ( tan ( angle s ) ) - H / ( tan ( angle α ) ) ] \qquad Constraint 1$$
$$P \geq ABS [ H / ( tan ( angle t ) ) - H / ( tan ( angle α ) ) ] \qquad Constraint 2$$
$$P \leq ABS [ H / ( tan ( angle ts ) ) - H / ( tan ( angle α ) ) ] \qquad Constraint 3$$
$$and$$
$$P \leq ABS [ H / ( tan ( angle ss ) ) - H / ( tan ( angle α ) ) ] \qquad Constraint 4$$

12. The direct reflection system of claim 1, wherein the windshield display is mounted within a dashboard of the vehicle such that a top surface of a direct reflection system assembly is flush with an external surface of the dashboard.

13. The direct reflection system of claim 12, wherein the top surface is an outermost surface of the direct reflection system assembly, where the direct reflection system assembly comprises the windshield display and the filter film, such that the outermost surface of the direct reflection system assembly is an external surface of the filter film.

14. The direct reflection system of claim 12, wherein the top surface is an outer surface of the windshield display.

15. The direct reflection system of claim 1, wherein the windshield display is mounted on top of an external surface of a dashboard.

16. The direct reflection system of claim 1, wherein the windshield display is embedded within a well of a dashboard.

17. The direct reflection system of claim 1, wherein a viewing portion of the reflective surface is tinted or otherwise darkened with a dark colored print.

18. The direct reflection system of claim 1, wherein the reflective surface is a windshield.

19. The direct reflection system of claim 1, wherein a plurality of windshield displays are mounted upon or embedded in a dashboard.

20. The direct reflection system of claim 1, wherein the windshield display is a thin-film-transistor, or TFT.
